(19) United States
(12) Patent Application Publication
(10) Pub. No.: US 2015/0336802 A1
(43) Pub. Date: Nov. 26, 2015

(54) METHOD OF PURIFYING SILICON

(71) Applicant: Silicor Materials Inc., San Jose, CA (US)

(72) Inventor: Paul A. Mancini, Mississauga (CA)

(73) Assignee: Silicor Materials Inc., San Jose, CA (US)

(21) Appl. No.: 14/409,430

(22) PCT Filed: Jun. 25, 2013
(86) PCT No.: PCT/US2013/047493

§ 371 Date: Dec. 18, 2014

Related U.S. Application Data
(60) Provisional application No. 61/663,865, filed on Jun. 25, 2012.

(51) Int. Cl. C01B 33/037

(52) U.S. Cl. CPC C01B 33/037; C01P 2006/80

(57) ABSTRACT

A method comprises forming a first molten liquid from a solvent metal and sodium carbonate, contacting the first molten liquid with silicon to form a second molten liquid, cooling the second molten liquid to provide silicon crystals and a mother liquor, and separating the silicon crystals from the mother liquor.

### RELATED APPLICATIONS

This application claims the benefit of priority to U.S. Provisional Application No. 61/663,865, filed Jun. 25, 2012, which is hereby incorporated by reference in its entirety.

### SUMMARY

The present invention provides for a method that includes: (a) forming a first molten liquid from a solvent metal and sodium carbonate; (b) contacting the first molten liquid with silicon to form a second molten liquid; (c) cooling the second molten liquid to provide silicon crystals and a mother liquor; and (d) separating the silicon crystals from the mother liquor.

The present invention also provides for a method for purifying metallurgical grade silicon with a phosphorous level up to about 60 ppmw and a boron level up to about 15 ppmw. The method includes: (a) forming a first molten liquid from a solvent metal and sodium carbonate, wherein the solvent metal includes aluminum; (b) contacting the first molten liquid with silicon to form a second molten liquid; (c) cooling the second molten liquid to provide silicon crystals and a mother liquor; and (d) separating the silicon crystals from the mother liquor. The silicon crystals separated from the mother liquor include less than about 4 ppmw phosphorous. The silicon crystals separated from the mother liquor include less than about 3,000 ppmw aluminum. The mother liquor separated from the silicon crystals include at least about 1,000 ppmw aluminum.

The present invention also provides for a method that includes: (a) forming a first molten liquid from a solvent metal and sodium oxide; (b) contacting the first molten liquid with silicon to form a second molten liquid; (c) cooling the second molten liquid to provide silicon crystals and a mother liquor; and (d) separating the silicon crystals from the mother liquor.

The present invention also provides for a method that includes: (a) forming a first molten liquid from a solvent metal and sodium; (b) contacting the first molten liquid with silicon to form a second molten liquid; (c) cooling the second molten liquid to provide silicon crystals and a mother liquor; and (d) separating the silicon crystals from the mother liquor.

In specific embodiments, the method of the present invention is a method for purifying silicon. In additional specific embodiments, the method of the present invention is a method for providing a suitable separation between the resulting silicon crystals and the aluminum.

During the process of removing the liquid eutectic from the silicon crystals in the fractional solidification mould, invariably a large portion of eutectic remains trapped with the silicon crystals both in a frozen and liquid state. The carryover of eutectic poses two major problems. First, when the carry liquid eutectic solidifies it can form large chunks of material with the silicon crystals that cannot be moved to the next process, but instead is recycled. Second, all eutectic that is carried forward to the next process is typically discarded or converted into a by-product that is much less valuable than the eutectic itself.

To reduce the amount of eutectic carried forward in the process, an addition of sodium carbonate (Na₂CO₃) flux is added to an aluminum melt. The high temperature of the melt causes release of carbon dioxide (CO₂), likely leaving behind sodium oxide (Na₂O). When the flux has been completely mixed into the aluminum melt, silicon crystals are added during the melt, which is brought to pour temperature. During this time a small amount of elemental sodium from the flux is incorporated into the aluminum silicon melt. The added sodium reduces the liquidus and eutectic temperatures. The eutectic temperature can be reduced by as much as about 6° C. This reduction in the solidification temperature can produce a more fluid liquid while also allowing for more time to drain eutectic from the mould.

In additional specific embodiments, with the addition of a source of sodium (e.g., sodium carbonate), a larger amount of eutectic was poured off the silicon flakes, and the subsequent acid line generates a less vigorous reaction. In specific embodiments, the method of the present invention improves the purity of the silicon crystals that emerge from each crystallization. In additional specific embodiments, the method of the present invention reduces the consumption of reagents in the acid line and results in the acid-aluminum reaction being easier to control. Since each particular batch of silicon crystals are relatively purer, each batch that is recrystallized from that batch should also be purer, thus the silicon that emerges from the cascade process should be purer due to the more effective separation allowed by the present invention. Additionally, a greater proportion of the aluminum eutectic ends up in the aluminum alloy that can be eventually sold as a final product.

In specific embodiments, the method of the present invention reduces the amount (or level) of phosphorous contained within silicon. In additional specific embodiments, the method of the present invention employs a sodium-containing substance to purify silicon. In additional specific embodiments, the method of the present invention employs a sodium-containing substance to reduce the amount (or level) of phosphorous contained within silicon.

In specific embodiments, the method of the present invention employs a sodium-containing substance to increase the amount of mother liquor obtained via a solvent metal extraction. In additional specific embodiments, the method of the present invention employs a sodium-containing substance to decrease the amount of solvent metal located within the purified silicon, obtained via a solvent metal extraction.

In specific embodiments, the method of the present invention lowers the solidus temperature for a mixture of silicon and solvent metal. In additional specific embodiments, the method of the present invention employs a sodium-containing substance, which lowers the solidus temperature for a mixture of silicon and solvent metal.

In specific embodiments, the method of the present invention shifts the liquidus line and eutectic chemistry toward a greater silicon concentration, for a mixture of silicon and solvent metal. In specific embodiments, the method of the present invention employs a sodium-containing substance, which shifts the liquidus line and eutectic chemistry toward a greater silicon concentration, for a mixture of silicon and solvent metal.

### BRIEF DESCRIPTION OF THE DRAWINGS

FIG. 1 illustrates a block flow diagram of a method for forming a molten liquid from a solvent metal and sodium carbonate, and the use of that molten liquid in contacting silicon.

FIG. 2 illustrates a block flow diagram of a method for forming a molten liquid from a solvent metal and sodium bicarbonate, and the use of that molten liquid in contacting silicon.

FIG. 3 illustrates a block flow diagram of a method for forming a molten liquid from a solvent metal and sodium oxide, and the use of that molten liquid in contacting silicon.

FIG. 4 illustrates a block flow diagram of a method for forming a molten liquid from a solvent metal and sodium, and the use of that molten liquid in contacting silicon.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Recitation in a claim to the effect that first a step is performed, then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps may also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### Definitions

As used herein, “purifying” refers to the physical separation of a substance of interest from one or more foreign or contaminating substances. In contrast, “impurities” or “impurity” refers to the one or more foreign or contaminating substances that are undesirable.

As used herein, “molten” or “molten liquid” refers to one or more substances, together, that are melted.

As used herein, “melting” refers to the process of heating one or more solid substances to a point (called the melting point), or above, where they turn into a liquid. As such, the “melting” refers to a substance changing from a solid to a liquid, when exposed to sufficient heat.

As used herein, “sodium carbonate” refers to a compound of the molecular formula Na₂CO₃, which is the sodium salt of carbonic acid.

As used herein, “aluminum” refers to the chemical element that has the symbol Al and atomic number 13. The term includes metal aluminum or elemental aluminum (Al⁰), or an alloy thereof. The aluminum will typically be used as a solvent metal.

As used herein, “solvent metal” refers to one or more metals, or an alloy thereof, which upon heating, can effectively dissolve silicon, resulting in a molten liquid. Suitable exemplary solvent metals include, e.g., at least one of aluminum, copper, tin, zinc, antimony, silver, bismuth, cadmium, gallium, indium, magnesium, lead, and alloys thereof.

As used herein, an “alloy” refers to a homogeneous mixture of two or more elements, at least one of which is a metal, and where the resulting material has metallic properties. The resulting metallic substance usually has different properties (sometimes significantly different) from those of its components.

As used herein, “solidifying” refers to the process of cooling one or more liquid substances (e.g., molten liquid) below a point (called the melting point), where they turn into a solid. As such, the “solidifying” refers to a substance changing from a liquid to a solid, upon cooling.

As used herein, “eutectic” refers to the proportion of constituents in an alloy or other mixture that yields the lowest possible complete melting point. In all other proportions, the mixture will not have a uniform melting point; some of the mixture will remain solid and some liquid. At the eutectic, the solidus and liquidus temperatures are the same.

In the diagram above, substance X consists of two components, A and B (approximately 80% A and 20% B). Above the liquidus (the temperature at which the first solid begins to form) both components are liquid. As the temperature drops to the liquidus, component A starts to solidify, and the remaining liquid becomes less rich in component A and more rich in component B. When the temperature has dropped to the solidus, which is the same as the eutectic temperature, solid B starts to form as well. Below the solidus, the entire mixture is solid. A liquid of composition Y (consisting of approximately 80% B and 20% A) would cool in a similar manner, but with solid B forming first. Typically, a mixture of eutectic proportions is always either entirely solid or entirely liquid. See, The American Heritage® Science Dictionary, 2010 by Houghton Mifflin Harcourt Publishing Company. Published by Houghton Mifflin Harcourt Publishing Company.

As used herein, “solidus” refers to the temperature below which a mixture is completely solid.

As used herein, “liquidus” refers to the maximum temperature at which crystals can co-exist with the melt in thermodynamic equilibrium. Above the liquidus temperature the material is homogeneous and liquid at equilibrium. Below the liquidus temperature more and more crystals may form in the melt if one waits a sufficiently long time, depending on the material. However, even below the liquidus temperature homogeneous glasses can be obtained through sufficiently fast cooling, i.e., through kinetic inhibition of the crystallization process.

As used herein, “separating” refers to the process of removing a substance from another substance (e.g., removing a solid or a liquid from a mixture) or separating a portion of a substance from another portion (e.g., removing a part of a solid from another part of the solid). The process can employ any technique known to those of skill in the art, e.g., decanting the mixture, skimming one or more liquids from the mixture, centrifuging the mixture, filtering the solids from the mixture, cutting a solid to remove a portion thereof, or a combination thereof. The separation can be a partial or complete separation.

As used herein, “boron” refers to the chemical element that has the symbol B and atomic number 5. The term includes elemental boron (B⁰) as well as compounds that include boron (i.e., boron-containing compounds that include B³⁺, B²⁺, or B⁺), and combinations thereof.

As used herein, “phosphorous” refers to the chemical element that has the symbol P and atomic number 15. The term includes elemental phosphorous (P⁰) as well as compounds that include phosphorous (i.e., phosphorous-containing compounds that include P⁵⁺, P⁴⁺, P³⁺, P²⁺, P⁺, P⁻¹, P⁻², or P−3), and combinations thereof.

As used herein, “sodium” refers to the chemical element that has the symbol Na and atomic number 11. The term includes elemental sodium (Na⁰) as well as compounds that include sodium (i.e., sodium-containing compounds that include Na⁺ or Na⁻¹), and combinations thereof. Representative sodium-containing compounds include, e.g., sodium oxide, sodium carbonate and sodium bicarbonate.

As used herein, “silicon” refers to the chemical element that has the symbol Si and atomic number 14. The term includes metal or elemental silicon (Si⁰), or an alloy thereof.

As used herein, “metallurgical grade silicon” refers to relatively pure (e.g., at least about 96.0 wt. %) silicon.

As used herein, “crystalline” includes the regular, geometric arrangement of atoms in a solid. As such, “silicon crystals” refers to silicon having relatively regular, geometric arrangement of the silicon atoms in a solid state.

As used herein, “forming a first molten liquid from a solvent metal and sodium carbonate” refers to a first molten liquid that is formed from a solvent metal and sodium carbonate. The first molten liquid can be formed from the direct introduction of these specific substances (i.e., solvent metal and sodium carbonate), or can be formed from any suitable substances that subsequent to their introduction, provide for the solvent metal and sodium carbonate. For example, the “forming a first molten liquid from a solvent metal and sodium carbonate” can include the direct introduction of solvent metal and sodium carbonate to form a first molten liquid. Alternatively, the “forming a first molten liquid from a solvent metal and sodium carbonate” can include the introduction of solvent metal and sodium bicarbonate to form a first molten liquid, wherein after the introduction of these substances the sodium bicarbonate is converted to sodium carbonate. As such, “forming a first molten liquid from a solvent metal and sodium carbonate” includes a first molten liquid formed from the introduction of a solvent metal and sodium carbonate, as well as a first molten liquid formed from the introduction of substances that subsequently provide for a solvent metal and sodium carbonate.

As used herein, “forming a first molten liquid from a solvent metal and sodium oxide” refers to a first molten liquid that is formed from a solvent metal and sodium oxide. The first molten liquid can be formed from the direct introduction of these specific substances (i.e., solvent metal and sodium oxide), or can be formed from any suitable substances that subsequent to their introduction, provide for the solvent metal and sodium oxide. For example, the “forming a first molten liquid from a solvent metal and sodium oxide” can include the direct introduction of solvent metal and sodium oxide to form a first molten liquid. Alternatively, the “forming a first molten liquid from a solvent metal and sodium oxide” can include the introduction of solvent metal and sodium carbonate to form a first molten liquid, wherein after the introduction of these substances the sodium carbonate is converted to sodium oxide. As such, “forming a first molten liquid from a solvent metal and sodium oxide” includes a first molten liquid formed from the introduction of a solvent metal and sodium oxide, as well as a first molten liquid formed from the introduction of substances that subsequently provide for a solvent metal and sodium oxide.

As used herein, “forming a first molten liquid from a solvent metal and sodium” refers to a first molten liquid that is formed from a solvent metal and sodium. The first molten liquid can be formed from the direct introduction of these specific substances (i.e., solvent metal and sodium), or can be formed from any suitable substances that subsequent to their introduction, provide for the solvent metal and sodium. For example, the “forming a first molten liquid from a solvent metal and sodium” can include the direct introduction of solvent metal and elemental sodium to form a first molten liquid. Alternatively, the “forming a first molten liquid from a solvent metal and sodium” can include the direct introduction of solvent metal and sodium oxide to form a first molten liquid. Alternatively, the “forming a first molten liquid from a solvent metal and sodium” can include the introduction solvent metal and sodium carbonate to form a first molten liquid. Alternatively, the “forming a first molten liquid from a solvent metal and sodium” can include the introduction solvent metal and sodium bicarbonate to form a first molten liquid. In the instances above, elemental sodium or sodium-containing compound (e.g., sodium oxide, sodium carbonate or sodium bicarbonate) is introduced, and together with the solvent metal, forms the first molten liquid. This occurs irrespective of whether or not the elemental sodium or sodium-containing compound is chemically converted to another sodium-containing compound. As such, “forming a first molten liquid from a solvent metal and sodium” includes a first molten liquid formed from the introduction of a solvent metal and sodium, as well as a first molten liquid formed from the introduction of substances that subsequently provide for a solvent metal and sodium.

As used herein, “contacting” refers to the act of touching, making contact, or of bringing substances into immediate proximity.

As used herein, “decanting” or “decantation” includes pouring off a fluid, leaving a sediment or precipitate, thereby separating the fluid from the sediment or precipitate.

As used herein, “filtering” or “filtration” refers to a mechanical method to separate solids from liquids by passing the feed stream through a porous sheet such as a ceramic or metal membrane, which retains the solids and allows the liquid to pass through. This can be accomplished by gravity, pressure or vacuum (suction). The filtering effectively separates the sediment and/or precipitate from the liquid.

As used herein, “mother liquor” refers to the part of a solution that is left over after crystallization. In crystallization, a solid (usually impure) is dissolved in a solvent at high temperature, taking advantage of the fact that most solids' solubilities are higher at higher temperatures. As the solution cools, the solubility of the solute in the solvent will gradually become smaller. The resultant solution is described as supersaturated, meaning that there is more solute dissolved in the solution than would be predicted by its solubility at that temperature. Crystallization can then be induced from this supersaturated solution and the resultant pure crystals removed by such methods as vacuum filtration and centrifugal separators. The remaining solution, once the crystals have been filtered out, is known as the mother liquor, and will contain a portion of the original solute (as predicted by its solubility at that temperature) as well as any impurities that were not filtered out. Second and third crops of crystals can then be harvested from the mother liquor.

As used herein, “batch” or “batch production” refers to the method of manufacturing, in which the object in question is created stage by stage over a series of workstations.

As used herein, “continuous” or “continuous production” refers to the method used to manufacture, produce, or process materials without interruption. Continuous production is called a continuous process or a continuous flow process because the materials, either dry bulk or fluids that are being processed are continuously in motion, undergoing chemical reactions or subject to mechanical or heat treatment. Continuous usually means operating 24 hours per day, seven days per week with infrequent maintenance shutdowns, such as semi-annual or annual.

Particle size is a notion introduced for comparing dimensions of solid particles. The particle size of a spherical object can be unambiguously and quantitatively defined by its diameter. However, a typical material object is likely to be irregular in shape and non-spherical. There are several methods for measuring particle size. Some of them are based on light, other on ultrasound, or electric field, or gravity, or centrifugation.

As used herein, “average mean diameter” is an average of particle size, and refers to an average of the diameter of a set of particles.

As used herein, “sodium oxide” refers to a chemical compound with the formula Na₂O.

As used herein, “sodium bicarbonate” or “sodium hydrogen carbonate” refers to a chemical compound with the formula NaHCO₃.

As used herein, “in situ” refers to in the mixture, or in the reaction mixture.

As used herein, “evolve” or “evolves” refers to the production and/or release of gas from a mixture, e.g., from a liquid mixture.

It is appreciated that those of skill in the art understand that a mixture of substances is typically characterized by those starting materials or intermediate components (e.g., solvent metal, sodium carbonate and silicon) that are useful in making the mixture. While these materials may undergo a substantial conversion, reference to the mixture as including these materials or substances is acceptable and appropriate to those of skill in the art. For example, a molten liquid can be formed from aluminum and sodium carbonate. Subsequent to the introduction of these substances, any one or more of these substances can undergo a chemical and/or physical conversion, such that they may no longer expressly and literally meet the criteria to be classified as aluminum or sodium carbonate. Reference to the mixture as including aluminum and sodium carbonate is, however, acceptable and appropriate to those of skill in the art. This is so, even though it is believed that upon contacting (or forming) a molten liquid with aluminum, sodium carbonate will decompose to provide sodium oxide and carbon dioxide. Likewise, it is believed that upon contacting (or forming) a molten liquid with aluminum, sodium bicarbonate will decompose to provide sodium carbonate (and carbon dioxide), which will further decompose to provide sodium oxide and carbon dioxide. However, reference to the molten liquid as including aluminum and sodium carbonate (or aluminum and sodium bicarbonate) is appropriate.

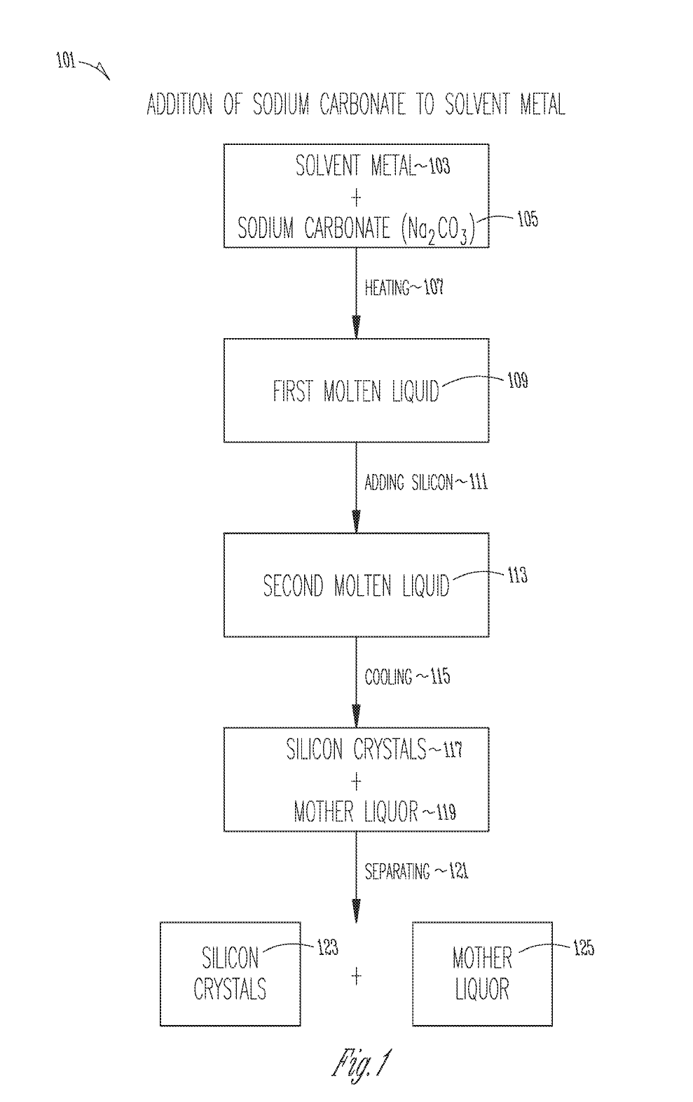

Referring to FIG. 1, a block flow diagram 101 is provided, illustrating a method for forming a first molten liquid 109 from a solvent metal 103 and sodium carbonate 105, and the use of that first molten liquid 109 in contacting silicon 111. Specifically, the solvent metal 103 and sodium carbonate 105 can be heated 107, to effectively form the first molten liquid 109. The first molten liquid 109 is contacted with silicon 111, to provide a second molten liquid 113. The second molten liquid 113 is cooled 115, to provide a mixture of silicon crystals 117 and mother liquor 119. The mixture of silicon crystals 117 and mother liquor 119 can then be separated 121, to provide for at least partially separated silicon crystals 123 and mother liquor 125.

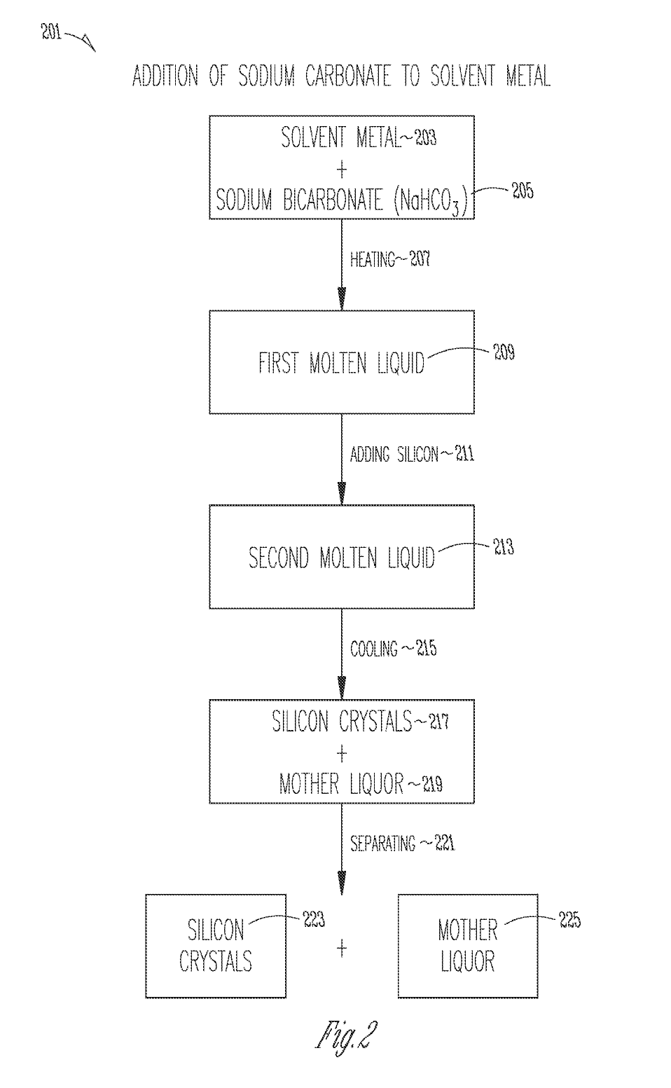

Referring to FIG. 2, a block flow diagram 201 is provided, illustrating a method for forming a first molten liquid 209 from a solvent metal 203 and sodium bicarbonate 205, and the use of that first molten liquid 209 in contacting silicon 211. Specifically, the solvent metal 203 and sodium bicarbonate 205 can be heated 207, to effectively form the first molten liquid 209. The first molten liquid 209 is contacted with silicon 211, to provide a second molten liquid 213. The second molten liquid 213 is cooled 215, to provide a mixture of silicon crystals 217 and mother liquor 219. The mixture of silicon crystals 217 and mother liquor 219 can then be separated 221, to provide for at least partially separated silicon crystals 223 and mother liquor 225.

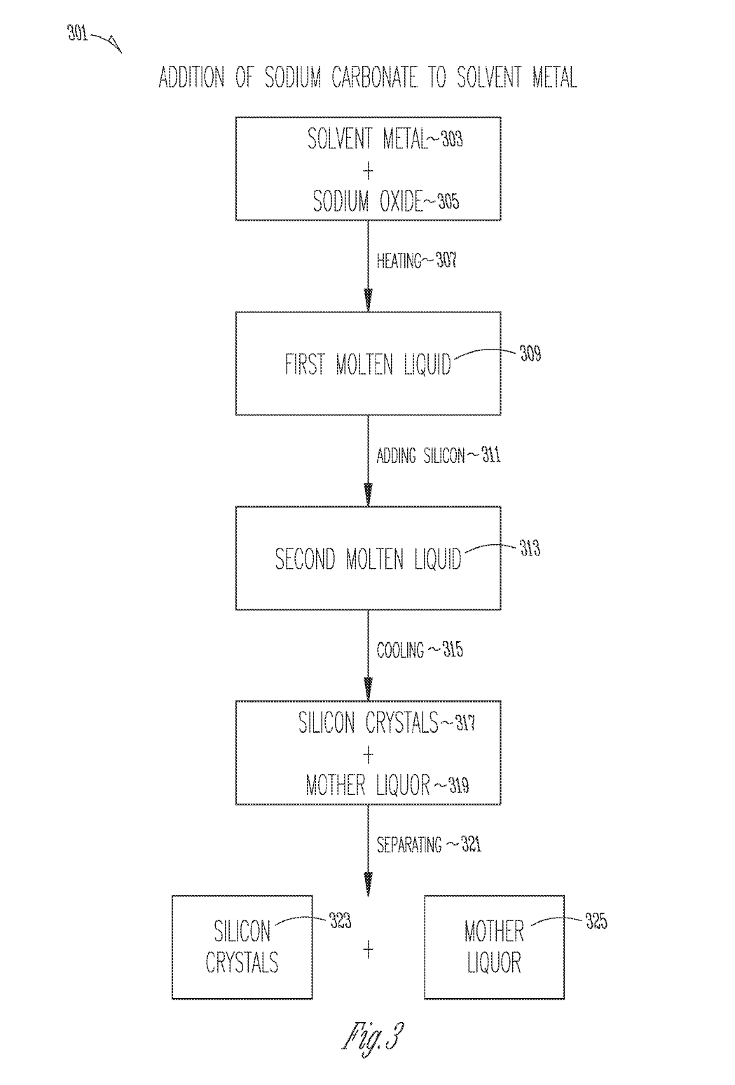

Referring to FIG. 3, a block flow diagram 301 is provided, illustrating a method for forming a first molten liquid 309 from a solvent metal 303 and sodium oxide 305, and the use of that first molten liquid 309 in contacting silicon 311. Specifically, the solvent metal 303 and sodium oxide 305 can be heated 307, to effectively form the first molten liquid 309. The first molten liquid 309 is contacted with silicon 311, to provide a second molten liquid 313. The second molten liquid 313 is cooled 315, to provide a mixture of silicon crystals 317 and mother liquor 319. The mixture of silicon crystals 317 and mother liquor 319 can then be separated 321, to provide for at least partially separated silicon crystals 323 and mother liquor 325.

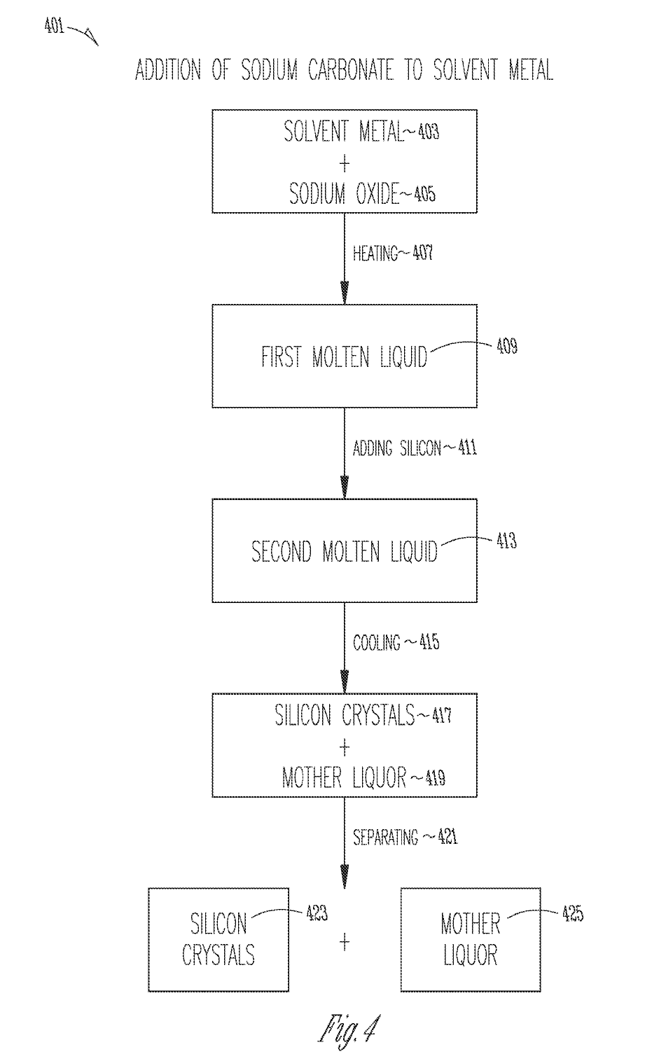

Referring to FIG. 4, a block flow diagram 401 is provided, illustrating a method for forming a first molten liquid 409 from a solvent metal 403 and sodium 405, and the use of that first molten liquid 409 in contacting silicon 411. Specifically, the solvent metal 403 and sodium 405 can be heated 407, to effectively form the first molten liquid 409. The first molten liquid 409 is contacted with silicon 411, to provide a second molten liquid 413. The second molten liquid 413 is cooled 415, to provide a mixture of silicon crystals 417 and mother liquor 419. The mixture of silicon crystals 417 and mother liquor 419 can then be separated 421, to provide for at least partially separated silicon crystals 423 and mother liquor 425.

The solvent metal 103 can be contacted with sodium carbonate 105. Together, these substances can be heated 107 to form the first molten liquid 109. Alternatively (not shown), the solvent metal 103 can be heated 107 to form a molten solvent metal, and the sodium carbonate 105 can be added to that molten solvent metal to provide the first molten liquid 109.

The solvent metal 203 can be contacted with sodium bicarbonate 205. Together, these substances can be heated 207 to form the first molten liquid 209. Alternatively (not shown), the solvent metal 203 can be heated 207 to form a molten solvent metal, and the sodium bicarbonate 205 can be added to that molten solvent metal to provide the first molten liquid 209.

The solvent metal 303 can be contacted with sodium oxide 305. Together, these substances can be heated 307 to form the first molten liquid 309. Alternatively (not shown), the solvent metal 303 can be heated 307 to form a molten solvent metal, and the sodium oxide 305 can be added to that molten solvent metal to provide the first molten liquid 309.

The solvent metal 403 can be contacted with sodium 405. Together, these substances can be heated 407 to form the first molten liquid 409. Alternatively (not shown), the solvent metal 403 can be heated 407 to form a molten solvent metal, and the sodium 405 can be added to that molten solvent metal to provide the first molten liquid 409.

The heating (107, 207, 307 or 407) can be carried out under suitable conditions (e.g., in any suitable manner, employing any suitable vessel and heating apparatus, for any suitable period of time, and at any suitable rate), provided the first molten liquid (109, 209, 309 or 409) is effectively obtained. For example, the heating (107, 207, 307 or 407) can be carried out, to achieve a temperature that will effectively form a first molten liquid (109, 209, 309 or 409). For example, the temperature can be at least about 650° C.

The silicon (111, 211, 311 or 411) can be contacted with the first molten liquid (109, 209, 309 or 409). Alternatively (not shown), the silicon (111, 211, 311 or 411) can be contacted with the solvent metal (103, 203, 303 or 403), and together they can be heated to form a molten liquid. To this molten liquid can be added the sodium carbonate 105, sodium bicarbonate 205, sodium oxide 305 or sodium 405. Alternatively (not shown), the silicon (111, 211, 311 or 411) can be contacted with the solvent metal (103, 203, 303 or 403) and the sodium carbonate 105, sodium bicarbonate 205, sodium oxide 305 or sodium 405. Together, these substances can be heated, to form a molten liquid (109, 209, 309 or 409). Irrespective of the specific manner in which the second molten liquid (113, 213, 313 or 413) is formed, the second molten liquid (113, 213, 313 or 413) is cooled (115, 215, 315 or 415), to effectively provide silicon crystals (117, 217, 317 or 417) and mother liquor (119, 219, 319 or 419).

The cooling (115, 215, 315 or 415) can be carried out under suitable conditions (e.g., in any suitable manner, employing any suitable vessel and optional cooling apparatus, for any suitable period of time, and at any suitable rate), provided the silicon crystals (117, 217, 317 or 417) and mother liquor (119, 219, 319 or 419) are obtained. For example, the cooling (115, 215, 315 or 415) can be carried out at about room temperature (about 20° C.), for an extended period of time. Alternatively, the cooling (115, 215, 315 or 415) can be carried out at a temperature above the solidus temperature. More specifically, the cooling (115, 215, 315 or 415) can be carried out between the solidus and the liquidus temperatures.

The mixture of silicon crystals (117, 217, 317 or 417) and mother liquor (119, 219, 319 or 419) that are formed from the cooling (115, 215, 315 or 415) of the second molten liquid (113, 213, 313 or 413) can be separated (121, 221, 321 or 421), to provide for silicon crystals (123, 223, 323 or 424) and mother liquor (125, 225, 325 or 425). The separation (121, 221, 321 or 421) can be a partial or complete separation. The separation (121, 221, 321 or 421) can be carried out under suitable conditions (e.g., in any suitable manner, employing any suitable apparatus), provided silicon crystals (123, 223, 323 or 424) and mother liquor (125, 225, 325 or 425) are obtained. For example, the separation (121, 221, 321 or 421) can employ decanting the mixture, skimming one or more liquids from the mixture, centrifuging the mixture, filtering the solids from the mixture, cutting a solid to remove a portion thereof, or a combination thereof.

Specific ranges, values, and embodiments provided below are for illustration purposes only and do not otherwise limit the scope of the disclosed subject matter, as defined by the claims. The specific ranges, values, and embodiments described below encompass all combinations and sub-combinations of each disclosed range, value, and embodiment, whether or not expressly described as such.

### Specific Ranges, Values, and Embodiments

In a specific embodiment, the method described herein is employed to purify silicon. In an additional specific embodiment, the method is employed to purify metallurgical grade (MG) silicon. In an additional specific embodiment, the method is employed to purify upgraded metallurgical grade (UMG) silicon.

In an additional specific embodiment, the method is employed to purify metallurgical grade silicon, with a phosphorous level up to about 80 ppmw, up to about 60 ppmw, or up to about 40 ppmw. In an additional specific embodiment, the method is employed to purify metallurgical grade silicon, with a boron level up to about 30 ppmw, up to about 15 ppmw, or up to about 10 ppmw.

In a specific embodiment, the method described herein is employed to obtain purified silicon that is at least partially purified from phosphorous. In an additional specific embodiment, the method is employed to obtain purified silicon that is at least partially purified from phosphorous, such that the purified silicon includes less than about 8 ppmw phosphorous, less than about 4 ppmw phosphorous, less than about 3 ppmw phosphorous, or less than about 2 ppmw phosphorous.

In a specific embodiment, the method described herein is employed to obtain purified silicon that includes a relatively minimal amount of aluminum, even when aluminum is employed as a solvent metal. In an additional specific embodiment, the method described herein is employed to obtain purified silicon that includes less than about 5,000 ppmw aluminum. In an additional specific embodiment, the method described herein is employed to obtain purified silicon that includes less than about 3,000 ppmw aluminum. In an additional specific embodiment, the method described herein is employed to obtain purified silicon that includes less than about 1,500 ppmw aluminum.

In a specific embodiment, the method described herein is employed to provide a purified silicon, obtained from a mother liquor. In an additional specific embodiment, the mother liquor includes a significant and appreciable amount of solvent metal. In an additional specific embodiment, the mother liquor includes at least about 500 ppmw solvent metal. In an additional specific embodiment, the mother liquor includes at least about 1,000 ppmw solvent metal. In an additional specific embodiment, the mother liquor includes at least about 2,500 ppmw solvent metal. In an additional specific embodiment, the mother liquor includes at least about 5,000 ppmw solvent metal. In an additional specific embodiment, the mother liquor includes at least about 10,000 ppmw solvent metal.

In an additional specific embodiment, the mother liquor includes a significant and appreciable amount of aluminum. In an additional specific embodiment, the mother liquor includes at least about 500 ppmw aluminum. In an additional specific embodiment, the mother liquor includes at least about 1,000 ppmw aluminum. In an additional specific embodiment, the mother liquor includes at least about 2,500 ppmw aluminum. In an additional specific embodiment, the mother liquor includes at least about 5,000 ppmw aluminum. In an additional specific embodiment, the mother liquor includes at least about 10,000 ppmw aluminum.

In a specific embodiment, the solvent metal includes at least one of copper, tin, zinc, antimony, silver, bismuth, aluminum, cadmium, gallium, indium, magnesium, lead, an alloy thereof. In an additional specific embodiment, the solvent metal includes aluminum and at least one of copper, tin, zinc, antimony, silver, bismuth, cadmium, gallium, indium, magnesium, lead, an alloy thereof. In an additional specific embodiment, the solvent metal includes aluminum.

In a specific embodiment, the solvent metal is employed in the first molten liquid in an amount of at least about 90 wt. %. In an additional specific embodiment, the solvent metal is employed in the first molten liquid in an amount of at least about 95 wt. %. In an additional specific embodiment, the solvent metal is employed in the first molten liquid in an amount of at least about 99 wt. %.

In a specific embodiment, aluminum is employed as the solvent metal and is present in the first molten liquid in an amount of at least about 90 wt. %. In an additional specific embodiment, aluminum is employed as the solvent metal and is present in the first molten liquid in an amount of at least about 95 wt. %. In an additional specific embodiment, aluminum is employed as the solvent metal and is present in the first molten liquid in an amount of at least about 99 wt. %.

In a specific embodiment, the sodium-containing substance is employed in the first molten liquid in an amount of at least about 0.01 wt. %. In an additional specific embodiment, the sodium-containing substance is employed in the first molten liquid in an amount of at least about 0.10 wt. %. In an additional specific embodiment, the sodium-containing substance is employed in the first molten liquid in an amount of at least about 0.20 wt. %. In an additional specific embodiment, the sodium-containing substance is employed in the first molten liquid in an amount of at least about 0.30 wt. %.

In a specific embodiment, sodium carbonate is present in the first molten liquid in an amount of at least about 0.01 wt. %. In an additional specific embodiment, sodium carbonate is present in the first molten liquid in an amount of at least about 0.10 wt. %. In an additional specific embodiment, sodium carbonate is present in the first molten liquid in an amount of at least about 0.30 wt. %.

In a specific embodiment, the solvent metal and sodium-containing substance are employed, such that the weight ratio, upon addition, is about 10,000:1 to about 100:1, of solvent metal to sodium-containing substance. In an additional specific embodiment, the solvent metal and sodium-containing substance are employed, such that the weight ratio upon addition is about 5,000:1 to about 500:1, of solvent metal to sodium-containing substance. In an additional specific embodiment, the solvent metal and sodium-containing substance are employed, such that the weight ratio upon addition is about 2,500:1 to about 750:1, of solvent metal to sodium-containing substance. In an additional specific embodiment, the solvent metal and sodium-containing substance are employed, such that the weight ratio upon addition is about 1,000:1 to about 100:1, of solvent metal to sodium-containing substance. In an additional specific embodiment, the solvent metal and sodium-containing substance are employed, such that the weight ratio upon addition is about 500:1 to about 100:1, of solvent metal to sodium-containing substance. In an additional specific embodiment, the solvent metal and sodium-containing substance are employed, such that the weight ratio upon addition is about 1,000:3, of solvent metal to sodium-containing substance.

In a specific embodiment, the aluminum and sodium-containing substance are employed, such that the weight ratio, upon addition, is about 10,000:1 to about 100:1, of aluminum to sodium-containing substance. In an additional specific embodiment, the aluminum and sodium-containing substance are employed, such that the weight ratio upon addition is about 5,000:1 to about 500:1, of aluminum to sodium-containing substance. In an additional specific embodiment, the aluminum and sodium-containing substance are employed, such that the weight ratio upon addition is about 2,500:1 to about 750:1, of aluminum to sodium-containing substance. In an additional specific embodiment, the aluminum and sodium-containing substance are employed, such that the weight ratio upon addition is about 1,000:1 to about 100:1, of aluminum to sodium-containing substance. In an additional specific embodiment, the aluminum and sodium-containing substance are employed, such that the weight ratio upon addition is about 500:1 to about 100:1, of aluminum to sodium-containing substance. In an additional specific embodiment, the aluminum and sodium-containing substance are employed, such that the weight ratio upon addition is about 1,000:3, of aluminum to sodium-containing substance.

In a specific embodiment, the solvent metal and sodium bicarbonate are employed, such that the weight ratio, upon addition, is about 10,000:1 to about 100:1, of solvent metal to sodium bicarbonate. In an additional specific embodiment, the solvent metal and sodium bicarbonate are employed, such that the weight ratio upon addition is about 5,000:1 to about 500:1, of solvent metal to sodium bicarbonate. In an additional specific embodiment, the solvent metal and sodium bicarbonate are employed, such that the weight ratio upon addition is about 2,500:1 to about 750:1, of solvent metal to sodium bicarbonate. In an additional specific embodiment, the solvent metal and sodium bicarbonate are employed, such that the weight ratio upon addition is about 1,000:1 to about 100:1, of solvent metal to sodium bicarbonate. In an additional specific embodiment, the solvent metal and sodium bicarbonate are employed, such that the weight ratio upon addition is about 500:1 to about 100:1, of solvent metal to sodium bicarbonate. In an additional specific embodiment, the solvent metal and sodium bicarbonate are employed, such that the weight ratio upon addition is about 1,000:3, of solvent metal to sodium bicarbonate.

In a specific embodiment, the aluminum and sodium bicarbonate are employed, such that the weight ratio, upon addition, is about 10,000:1 to about 100:1, of aluminum to sodium bicarbonate. In an additional specific embodiment, the aluminum and sodium bicarbonate are employed, such that the weight ratio upon addition is about 5,000:1 to about 500:1, of aluminum to sodium bicarbonate. In an additional specific embodiment, the aluminum and sodium bicarbonate are employed, such that the weight ratio upon addition is about 2,500:1 to about 750:1, of aluminum to sodium bicarbonate. In an additional specific embodiment, the aluminum and sodium bicarbonate are employed, such that the weight ratio upon addition is about 1,000:1 to about 100:1, of aluminum to sodium bicarbonate. In an additional specific embodiment, the aluminum and sodium bicarbonate are employed, such that the weight ratio upon addition is about 500:1 to about 100:1, of aluminum to sodium bicarbonate. In an additional specific embodiment, the aluminum and sodium bicarbonate are employed, such that the weight ratio upon addition is about 1,000:3, of aluminum to sodium bicarbonate.

In a specific embodiment, the method described herein provides for purified silicon, in the form of crystals or flakes. In an additional specific embodiment, the method described herein provides for silicon crystals that have an average mean diameter of at least about 0.1 cm. In an additional specific embodiment, the method described herein provides for silicon crystals that have an average mean diameter of at least about 0.25 cm. In an additional specific embodiment, the method described herein provides for silicon crystals that have an average mean diameter of at least about 0.5 cm. In an additional specific embodiment, the method described herein provides for silicon crystals that have an average mean diameter of at least about 0.75 cm. In an additional specific embodiment, the method described herein provides for silicon crystals that have an average mean diameter of at least about 1.0 cm.

In a specific embodiment, the method described herein provides for purified silicon, on a commercial scale. In an additional specific embodiment, the method described herein provides for at least about 150 kg of purified silicon, at least about 240 kg of purified silicon, or at least about 500 kg of purified silicon.

In a specific embodiment, the method described herein is carried out in a batch manner or fashion. In an alternative embodiment, the method described herein is carried out in a continuous manner or fashion.

In a specific embodiment, any one or more of the steps is independently carried out, one or more times. In an additional specific embodiment, each of the steps is independently carried out, one or more times. In an additional specific embodiment, any one or more of the steps is independently repeated, one or more times. In an additional specific embodiment, each of the steps is independently repeated, one or more times.

In a specific embodiment, sodium carbonate is employed to form a molten liquid with the solvent metal. In an additional specific embodiment, sodium carbonate is contacted with the molten solvent metal. In an additional specific embodiment, sodium carbonate is contacted with the solvent metal, and together they are heated to form a molten liquid. In an additional specific embodiment, sodium carbonate is contacted with a molten mixture of solvent metal and silicon. In an additional specific embodiment, sodium carbonate is contacted with the solvent metal and silicon, and together they are heated to form a molten liquid.

In a specific embodiment, a sodium-containing substance is employed to form a molten liquid with the solvent metal. In an additional specific embodiment, a sodium-containing substance is contacted with the molten solvent metal. Subsequent to the formation or contact with the molten solvent metal, the sodium-containing substance can chemically decompose to provide sodium carbonate, sodium oxide, carbon dioxide, or a combination thereof.

In a specific embodiment, sodium oxide is formed in situ, from the introduction of a sodium-containing substance. In an additional specific embodiment, sodium oxide is formed in situ, from the introduction of sodium carbonate. In an additional specific embodiment, sodium oxide is formed in situ, from the introduction of sodium bicarbonate.

In a specific embodiment, sodium carbonate is formed in situ, from the introduction of a sodium-containing substance. In an additional specific embodiment, sodium carbonate is formed in situ, from the introduction of sodium bicarbonate.

In a specific embodiment, the introduction or addition of a sodium-containing substance evolves or releases a gas from the molten liquid. In an additional specific embodiment, the introduction or addition of a sodium-containing substance evolves or releases carbon dioxide from the molten liquid. In an additional specific embodiment, the introduction or addition of sodium carbonate evolves or releases carbon dioxide from the molten liquid. In an additional specific embodiment, the introduction or addition of sodium bicarbonate evolves or releases carbon dioxide from the molten liquid.

Specific enumerated embodiments [1] to [30] provided below are for illustration purposes only, and do not otherwise limit the scope of the disclosed subject matter, as defined by the claims. These enumerated embodiments encompass all combinations, sub-combinations, and multiply referenced (e.g., multiply dependent) combinations as described therein.

### Enumerated Embodiments

[1.] A method comprising:
(a) forming a first molten liquid from a solvent metal and sodium carbonate;
(b) contacting the first molten liquid with silicon to form a second molten liquid;
(c) cooling the second molten liquid to provide silicon crystals and a mother liquor; and
(d) separating the silicon crystals from the mother liquor.

[2.] A method for purifying metallurgical grade silicon with a phosphorous level up to about 60 ppmw and a boron level up to about 15 ppmw, the method comprising:
(a) forming a first molten liquid from a solvent metal and sodium carbonate, wherein the solvent metal comprises aluminum;
(b) contacting the first molten liquid with silicon to form a second molten liquid;
(c) cooling the second molten liquid to provide silicon crystals and a mother liquor; and
(d) separating the silicon crystals from the mother liquor;
wherein the silicon crystals separated from the mother liquor comprises less than about 4 ppmw phosphorous;
wherein the silicon crystals separated from the mother liquor comprise less than about 3,000 ppmw aluminum; and
wherein the mother liquor separated from the silicon crystals comprise at least about 1,000 ppmw aluminum.

[3.] A method comprising:
(a) forming a first molten liquid from a solvent metal and sodium oxide;
(b) contacting the first molten liquid with silicon to form a second molten liquid;
(c) cooling the second molten liquid to provide silicon crystals and a mother liquor; and
(d) separating the silicon crystals from the mother liquor.

[4.] A method comprising:
(a) forming a first molten liquid from a solvent metal and sodium;
(b) contacting the first molten liquid with silicon to form a second molten liquid;
(c) cooling the second molten liquid to provide silicon crystals and a mother liquor; and
(d) separating the silicon crystals from the mother liquor.

[5.] The method of any one of embodiments [1] and [3]-[4], which is a method for purifying silicon.

[6.] The method of any one of embodiments [1] and [3]-[4], which is a method for purifying silicon, wherein the silicon crystals are at least partially purified from phosphorous.

[7.] The method of any one of embodiments [1], [3]-[4] and [6], wherein the silicon that contacts the first molten liquid is metallurgical grade silicon.

[8.] The method of any one of embodiments [1], [3]-[4] and [6]-[7], wherein the silicon that contacts the first molten liquid is metallurgical grade silicon, with a phosphorous level up to about 60 ppmw.

[9.] The method of any one of embodiments [1], [3]-[4] and [6]-[8], wherein the silicon that contacts the first molten liquid is metallurgical grade silicon, with a boron level up to about 15 ppmw.

[10.] The method of any one of embodiments [1], [3]-[4] and [6]-[9], wherein the silicon crystals separated from the mother liquor comprises less than about 4 ppmw phosphorous.

[11.] The method of any one of embodiments [1], [3]-[4] and [6]-[10], wherein the silicon crystals separated from the mother liquor comprises less than about 3 ppmw phosphorous.

[12.] The method of any one of embodiments [1], [3]-[4] and [6]-[11], wherein the solvent metal comprises at least one of copper, tin, zinc, antimony, silver, bismuth, aluminum, cadmium, gallium, indium, magnesium, lead, and an alloy thereof.

[13.] The method of any one of embodiments [1], [3]-[4] and [6]-[12], wherein the solvent metal comprises aluminum.

[14.] The method of any one of embodiments [1]-[13], wherein the solvent metal comprises aluminum, and is employed in the first molten liquid in an amount of about 99.70 wt. %.

[15.] The method of any one of embodiments [1]-[14], wherein the sodium carbonate is employed in the first molten liquid in an amount of about 0.30 wt. %.

[16.] The method of any one of embodiments [1]-[15], wherein the first molten liquid is contacted with silicon in a weight ratio of about 1200:1000, of silicon to first molten liquid.

[17.] The method of any one of embodiments [1]-[16], wherein the cooling of the second molten liquid to provide the silicon crystals and the mother liquor is carried out to a temperature above the solidus temperature.

[18.] The method of any one of embodiments [1]-[17], wherein the cooling of the second molten liquid to provide the silicon crystals and the mother liquor is carried out to a temperature between the solidus and the liquidus temperature.

[19.] The method of any one of embodiments [1]-[18], wherein the silicon crystals separated from the mother liquor comprise less than about 3,000 ppmw aluminum.

[20.] The method of any one of embodiments [1]-[19], wherein the silicon crystals separated from the mother liquor comprise less than about 1,500 ppmw aluminum.

[21.] The method of any one of embodiments [1]-[20], wherein at least about 240 kg of silicon crystals is obtained.

[22.] The method of any one of embodiments [1]-[21], wherein any one or more of steps (a)-(d) is repeated one or more times.

[23.] The method of any one of embodiments [1]-[22], wherein each of steps (a)-(d) is independently repeated one or more times.

[24.] The method of any one of embodiments [1]-[23], carried out in a batch or continuous fashion.

[25.] The method of any one of embodiments [1]-[24], wherein the mother liquor comprises at least about 1,000 ppmw aluminum.

[26.] The method of any one of embodiments [1]-[25], wherein the silicon crystals have an average mean diameter of at least about 0.5 cm.

[27.] The method of any one of embodiments [1]-[26], wherein sodium oxide is formed in situ, from the sodium carbonate.

[28.] The method of any one of embodiments [1]-[27], wherein the sodium carbonate is formed in situ.

[29.] The method of any one of embodiments [1]-[28], wherein the sodium carbonate is formed in situ, from sodium bicarbonate.

[30.] The method of any one of embodiments [1]-[29], wherein the sodium carbonate evolves or releases carbon dioxide (CO₂) from the first molten liquid.

1. A method comprising:
(a) forming a first molten liquid from a solvent metal and at least one of sodium, sodium carbonate, and sodium oxide;
(b) contacting the first molten liquid with silicon to form a second molten liquid;
(c) cooling the second molten liquid to provide silicon crystals and a mother liquor; and
(d) separating the silicon crystals from the mother liquor.

2. (canceled)

3. The method of claim 1, wherein the silicon crystals are at least partially purified from phosphorous.

4. The method of claim 1, wherein the silicon that contacts the first molten liquid is metallurgical grade silicon.

5. The method of claim 1, wherein the silicon that contacts the first molten liquid has a phosphorous level up to about 60 ppmw.

6. The method of claim 1, wherein the silicon that contacts the first molten liquid has a boron level up to about 15 ppmw.

7. The method of claim 1, wherein the silicon crystals separated from the mother liquor comprises less than about 4 ppmw phosphorous.

8. The method of claim 1, wherein the silicon crystals separated from the mother liquor comprises less than about 3 ppmw phosphorous.

9. The method of claim 1, wherein the solvent metal comprises at least one of copper, tin, zinc, antimony, silver, bismuth, aluminum, cadmium, gallium, indium, magnesium, lead, and an alloy thereof.

10. (canceled)

11. The method of claim 1, wherein the solvent metal comprises aluminum, and is employed in the first molten liquid in an amount of about 99.70 wt. %.

12. The method of claim 1, wherein the at least one of sodium, sodium carbonate, and sodium oxide is employed in the first molten liquid in an amount of about 0.30 wt. %.

13. The method of claim 1, wherein the first molten liquid is contacted with silicon in a weight ratio of about 1200:1000 of silicon to first molten liquid.

14. The method of claim 1, wherein the cooling of the second molten liquid to provide the silicon crystals and the mother liquor is carried out to a temperature above the solidus temperature or at a temperature between the solidus and the liquidus temperature.

15-16. (canceled)

17. The method of claim 1, wherein the silicon crystals separated from the mother liquor comprise less than about 1,500 ppmw aluminum.

18. (canceled)

19. The method of claim 1, wherein any one or more of steps (a)-(d) is repeated one or more times.

20. The method of claim 1, wherein each of steps (a)-(d) is independently repeated one or more times.

21. (canceled)

22. The method of claim 1, wherein the mother liquor comprises at least about 1,000 ppmw aluminum.

23. (canceled)

24. The method of claim 1, wherein sodium oxide is formed in situ, from sodium carbonate.

25. The method of claim 1, wherein sodium carbonate is formed in situ.

26. (canceled)

27. The method of claim 1, wherein the at least one of the sodium, the sodium carbonate, and the sodium oxide evolves or releases carbon dioxide (CO₂) from the first molten liquid.

28. A method for purifying metallurgical grade silicon with a phosphorous level up to about 60 ppmw and a boron level up to about 15 ppmw, the method comprising:
(a) forming a first molten liquid from a solvent metal and sodium carbonate, wherein the solvent metal comprises aluminum;
(b) contacting the first molten liquid with silicon to form a second molten liquid;
(c) cooling the second molten liquid to provide silicon crystals and a mother liquor; and
(d) separating the silicon crystals from the mother liquor;
wherein the silicon crystals separated from the mother liquor comprises less than about 4 ppmw phosphorous;
wherein the silicon crystals separated from the mother liquor comprise less than about 3,000 ppmw aluminum; and
wherein the mother liquor separated from the silicon crystals comprise at least about 1,000 ppmw aluminum.

29-30. (canceled)
